(19) United States
(12) Patent Application Publication
(10) Pub. No.: US 2014/0277840 A1
(43) Pub. Date: Sep. 18, 2014

(54) VEHICLE IMMOBILIZER

(71) Applicant: Kevin King, Phoenix, AZ (US)

(72) Inventor: Kevin King, Phoenix, AZ (US)

(21) Appl. No.: 13/839,423

(22) Filed: Mar. 15, 2013

(51) Int. Cl. B60R 25/00

(52) U.S. Cl. CPC B60R 25/00
USPC 701/2; 701/1; 701/36

(57) ABSTRACT

Disclosed is a base unit that may be used to demobilize a vehicle. The base unit may include a microprocessor, a relay connected to the microprocessor, and at least one transceiver connected to the microprocessor. In example embodiments, the microprocessor may be configured to receive data related to a number of time increments to count, count a number of time increments, and activate the relay when it determines that no more time is to be counted.

### BACKGROUND

1. Field

Example embodiments are directed to an immobilizer that may be configured to immobilize a vehicle. Example embodiments are also directed to a system that uses the immobilizer, and methods that immobilize a vehicle.

2. Description of the Related Art

Lenders take considerable risk when loaning money to borrowers for a purchase of a car. Some borrowers, for example, after obtaining car, quit making their required car payments. Some lenders have turned to car immobilizers to the immobilize cars of borrowers who refuse to make their loan payments.

### SUMMARY

The inventor has discovered there is need for an improved vehicle immobilizer since conventional immobilizers are often unreliable or difficult to employ. Thus, the inventor has designed an improved vehicle immobilizer having improved safety features and usability. The vehicle immobilizer may be used in various types of vehicles including, but not limited to, cars, trucks, boats, and planes.

In accordance with example embodiments, a base unit may include a microprocessor, a relay connected to the microprocessor, and at least one transceiver connected to the microprocessor. In example embodiments the microprocessor may be configured to receive data related to a number of time increments to count, count a number of time increments, and activate the relay when it determines that no more time is to be counted. In example embodiments, the base unit may be installed in a vehicle to demobilize the vehicle.

In accordance with example embodiments a system may include an electronic storage device and a base unit. In example embodiments, the electronic storage device may have a memory and a second microprocessor configured to determine whether an activation code correctly corresponds to a reference code stored in the memory of the electronic storage device. In example embodiments the memory may be non-permanent to allow deletion of the reference code from the memory in the event the second microprocessor determines the activation code corresponds to the reference code. In example embodiments, the base unit may include a microprocessor, a relay connected to the microprocessor, and at least one transceiver connected to the microprocessor. In example embodiments the microprocessor may be configured to receive data related to a number of time increments to count, count a number of time increments, and activate the relay if it determines that no more time is to be counted. In example embodiments, the transceiver may receive a signal from the electronic storage device after the second microprocessor determines the activation code matches the reference code. In example embodiments, the signal may include the data related to the number of time increments to count.

### BRIEF DESCRIPTION OF THE DRAWINGS

Example embodiments are described in detail below with reference to the attached figures, wherein:

FIG. 1 is a view of a system accordance with example embodiments;

FIG. 2 is a view of a base unit in accordance with example embodiments;

FIG. 3 is a view of a base unit with a touch screen in accordance with example embodiments;

FIG. 4 is a view of a handheld device in accordance with example embodiments;

FIGS. 5A-5F are views of a hand held device in accordance with example embodiments;

FIG. 6 is a schematic of a KeyFob in accordance with example embodiments;

FIG. 7 is a schematic of a handheld device in accordance with example embodiments; and

FIG. 8 is a view of a remote KeyFob in accordance with example embodiments.

### DETAILED DESCRIPTION

Example embodiments of the invention will now be described with reference to the accompanying drawings. Example embodiments, however, should not be construed as limiting the invention since the invention may be embodied in different forms. Example embodiments illustrated in the figures are provided so that this disclosure will be thorough and complete. In the drawings, the sizes of components may be exaggerated for clarity.

In this application, when an element is referred to as being “on,” “attached to,” “connected to,” or “coupled to” another element, it can be directly on, attached to, connected to, or coupled to the other element or intervening elements that may be present. On the other hand, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application, the terms first, second, etc. are used to describe various elements, components, regions, layers, and/or sections. However, these elements, components, regions, layers, and/or sections should not be limited by these terms since these terms are only used to distinguish one element, component, region, layer, and/or section from other elements, components, regions, layers, and/or sections that may be present. For example, a first element, component, region, layer or section discussed below could be termed a second element, component, region, layer, or section.

In this application, spatial terms, such as “beneath,” “below,” “lower,” “over,” “above,” and “upper” (and the like) are used for ease of description to describe one element or feature's relationship to another element(s) or feature(s). The invention, however, is not intended to be limited by these spatial terms. For example, if an example of the invention illustrated in the figures is turned over, elements described as “over” or “above” other elements or features would then be oriented “under” or “below” the other elements or features. Thus, the spatial term “over” may encompass both an orientation of above and below. The device may be otherwise oriented (for example, rotated 45 degrees, 90 degrees, 180 degrees, or at other orientations) and the spatially relative descriptors used herein interpreted accordingly.

In this application, example embodiments may be described by referring to plan views and/or cross-sectional views which may be ideal schematic views. However, it is understood the views may be modified depending on manufacturing technologies and/or tolerances. Accordingly, the invention is not limited by the examples illustrated in the views, but may include modifications in configurations formed on the basis of manufacturing process. Therefore, regions illustrated in the figures are schematic and exemplary and do not limit the invention.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments are directed to an immobilizer that may be configured to demobilize a vehicle. Example embodiments are also directed to a system that uses the immobilizer, and methods that immobilize a vehicle.

FIG. 1 illustrates a vehicle immobilizer 10 in accordance with example embodiments. As shown in FIG. 1, the vehicle immobilizer 10 may include a base unit 16, a cellular connected remote server unit 90, and a handheld remote unit 14. As seen in FIG. 1, the base unit 16 may be connected to a starter circuit 17 between a starter 18 of a vehicle 12 and an ignition 20 of the vehicle 12. The base unit 16 may immobilize the vehicle 12 by disabling the starter circuit 17 thereby preventing the ignition 20 from activating the starter 18. In example embodiments, the base unit 16 may derive its power from a battery 22 of the vehicle 12. However, in example embodiments, the base unit 16 may contain an internal back-up battery for surviving a power loss within vehicle 12. In example embodiments the base unit 16 may contain a GPS receiver 39 and a GPS antenna 37 for obtaining vehicle location and speed. Also, in accordance with example embodiments, the base unit 16 may also contain a cellular transceiver 33 and a cellular antenna 35 for sending and receiving messages to the remote server unit 90. In example embodiments, an antenna 72, a cellular communication medium 70, the internet 80, the network 92, a database 94, and an email system 96 may be usable to help implement example embodiments.

The above description was does not limit example embodiments. For example, referring to FIG. 1, a vehicle immobilizer 10 according to example embodiments may include a base unit 16, a cellular connected remote server unit 90 and a dedicated short range line of sight wireless connected keyfob remote unit 60 in place of the handheld remote unit 14. The keyfob remote 60 may have a wireless transceiver 62 for sending and receiving messages to and from the base unit 16. The remote keyfob unit 60 may power itself and thus, may not be attached to vehicle 12. In example embodiments, the keyfob 60 may send messages and receive detected events and generated status messages in response to detected events from the base unit 16. In example embodiments, the remote keyfob unit 60 may allow temporary remote re-enablement via an emergency code entry through the keyfob keypad 69 in cases where the cellular coverage is missing or out of range. The remote keyfob unit 60 may have LED's 67 for displaying status information relating to the status message sent back from the base unit regarding the startability of a vehicle.

In example embodiments, the keyfob unit 60, as shown in FIGS. 6 and 7, may have its own microprocessor and embedded flash memory 66 serving as electronic storage means, a keypad 69, status LED's 69, and transceiver 64 indicated in FIG. 6. The transceiver 64 of the keyfob unit 60 of example embodiments may also be a radio transceiver with an antenna 62. The keyfob unit transceiver 64 may also use infrared light to communicate so long as the base unit transceiver 34 also uses infra red light to communicate.

The above descriptions do not limit example embodiments. For example, in example embodiments, a vehicle immobilizer 10 may have a base unit 16 with an attached graphical LCD 13 and a cellular connected remote unit 90. The attached graphical LCD 13 may have an integrated touchpad that may serve as a direct method for entering activation and emergency codes and displaying time remaining within a payment period, unit status and the like.

In another alternative embodiment, the remote server unit 90 may include a server running a software application running at an operations center. The software application may receive detected events and generated messages in response to detected events from the base unit 16 via a wireless cellular connection. These messages may be transmitted by base unit devices installed in vehicles or other products. Upon receiving a new paid up condition from a buyer, a lender may take an action, such as sending a new paid up message to the installed base unit 16 to re-enable the vehicle, or to further keep the vehicle 12 in the enabled condition or the like.

In addition to immobilizing the vehicle 12, the base unit 16 may keep track of a period of time by counting increments of time. While counting the increments, the base unit 16 may not immobilize the vehicle 12. After the increments have been counted, i.e. a period of time has passed, the base unit 16 may immobilize the vehicle 12.

As seen in FIGS. 2 and 3, an example of the base unit 16 may have a microprocessor 24, a flash memory 26, a piezoelectric buzzer 28, an accessory input sensor 30, a relay and immobilization circuit 32, a remote RF transceiver 34, semiconductor switch 17, a GPS receiver 39 (connected to an antenna 37), and a cellular communications transceiver 33. In example embodiments the microprocessor 24 may count increments of time using an internal oscillator based interrupt counter 36. The counter 36 may count at preset increments, for example, 50 ms increments. In example embodiments the base unit memory 26 (which may be a flash memory) may be usable for setting a checkpoint of time counted when counting is interrupted, for instance, in the event the base unit 16 loses power. Although example embodiments illustrate the base unit 16 as including a relay and immobilization circuit 32 as including a relay, example embodiments also may use, instead, a semiconductor, for example, a semiconductor switch (FET) as the relay and immobilization circuit 32.

In example embodiments, the accessory input sensor 30 may sense key in accessory position and accessory off position. Accessory off position occurs when the vehicle 12 is not in operation and the key in accessory position occurs before activation of the vehicle ignition 20. When the accessory input sensor 30 senses key in accessory position, the starter 18 may not be activated but the vehicle 12 draws power from the battery 22 for operation of powered vehicle devices known in the art, for example, vehicle windows, a vehicle radio, and a vehicle climate control system (not shown). When the accessory input sensor 30 senses the key in accessory position, the microprocessor 24 may determine whether time remains to be counted. If no time remains to be counted, the microprocessor 24 may activate the relay and immobilization circuit 32 to disable the starter circuit 17. If time does remain to be counted, the relay and immobilization circuit 32 may not disable the starter circuit. By determining whether to immobilize the vehicle 12 at a pre-ignition status, the immobilizer 10 may prevent immobilization during operation of the vehicle 12. In the event the microprocessor 24 determines that no increments remain to be counted in the key in accessory position, the microprocessor 24 may activate the piezoelectric buzzer 28 to provide an audible indication that the vehicle 12 will be or has been immobilized.

In example embodiments, the accessory input sensor 30 may monitor the key in accessory position and the accessory off position to prevent immobilization of the vehicle 12 during operation of the vehicle 12. In addition, immobilization may be prevented within a fixed time period after operation of the vehicle 12. In example embodiments, immobilization may be allowed only after the accessory input sensor 30 senses accessory off position for a time period greater than a preset time period, for example, one hour. Thus, in example embodiments, normal vehicle operation may continue before immobilization. This safety feature may also prevent immobilization after such events as momentary stalling of the vehicle 12, stops due to road emergencies, and stops initiated by law enforcement.

In example embodiments, the base unit 16 may receive the number of increments to count via a cellular transceiver 33. In example embodiments, the transceiver 33 may be a cellular radio transceiver and may have a cellular radio antenna 35. The cellular radio transceiver 33 may be advantageous because it may allow the base unit 16 to be inaccessible but still able to communicate with the remote server unit 90.

In example embodiments, the base unit 16 may receive the number of increments to count via the transceiver 34. In example embodiments, the transceiver 34 may be a radio transceiver and may have a radio antenna 38. The radio transceiver 34 may be advantageous because it allows the base unit 16 to be inaccessible but still able to communicate with either the handheld unit 14 or the remote keyfob 60. However, the transceiver 34 may use infrared light to communicate.

FIGS. 4 and 5 illustrate a non-limiting example of the handheld unit 14. As shown in FIGS. 4 and 5A-5E the example handheld unit 14 may have its own microprocessor 40, its own flash memory 42 which may serve as electronic storage device, as well as its own transceiver 44. The transceiver 44 of the handheld unit 14 may also be a radio transceiver with antenna 46. The handled unit transceiver 44 may also use infrared light to communicate so long as the base unit transceiver 34 also uses infrared light to communicate.

In example embodiments, the handheld unit memory 42 may store a plurality of reference codes. Each reference code may correspond to a number of increments representing a period of time. In example embodiments, the handheld unit memory 42 may store five years worth of reference codes corresponding to hours, days, weeks, and months. Each reference code may have a corresponding activation code. In example embodiments, activation codes may not be stored in the handheld unit memory 42, but instead may be manually entered via a keypad 48, which may serve as a device for entry of an activation code. The handheld unit microprocessor 40 may compare an entered activation code to stored reference codes, and if a corresponding reference code is found, the handheld unit microprocessor 40 may activate the handheld unit transceiver 44 and cause the transceiver 44 to send a signal to the base unit 16. The signal may carry with it the number of increments represented by the reference code that corresponded to the activation code.

In example embodiments, some the reference codes may be emergency codes corresponding to shortened periods of time. The handheld unit 14 may monitor a cycling period of time in which emergency codes may be entered. Unlike reference codes, the emergency codes may not be deleted or flagged for non-use after a match is found with a corresponding activation code. Instead, the emergency codes may be temporarily flagged for non-use until the next cycling period of time. In example embodiments, the cycling period may be a billing period and the emergency codes may represent periods of time, for example, one hour or half hour. Thus, the emergency codes may allow use of a vehicle even when no increments of time remain to be counted for such purposes as responding to an emergency, making payments, or returning the vehicle 12 to a lender.

In example embodiments, the handheld unit 14 may have a Graphical LCD 50 as shown in FIG. 4. The Graphical LCD 50 may provide a user interface to aid in the entry of activation codes and may display an amount of time remaining to be counted. In addition, the Graphical LCD 50 may serve as visual payment reminder function. In example embodiments, although the handheld unit 14 may have the same ability to count increments of time as the base unit 16, the handheld unit 14 may not accurately reflect the amount of increments remaining to be counted by the base unit, but may, nonetheless, provide a sufficient forewarning of vehicle immobilization. In example embodiments, the base unit 16 may constantly send a signal, preferably only during operation of the vehicle 12 so as not to drain the battery 22, to the handheld unit 14, with the remaining time to be counted.

In example embodiments, a method may utilize the immobilizer 10 to immobilize the vehicle 12 after a set of amount of time, for example, a payment period. For example, an example method may begin with a generation of reference codes representing a number of increments that represent a period of time. Activation codes corresponding to each reference code may also be generated. In example embodiments, each activation code may correspond to only one reference code and vice versa. The reference codes may then be stored in the handheld unit memory 42. In example embodiments, the reference code may be provided to the handheld unit microprocessor 40 via the memory 42 and the activation code may be provided to the microprocessor 40 via the keypad 48, but example embodiments are not limited thereto. For example, the microprocessor 40, serving as a microprocessor, may determine whether an activation code corresponds to any of the stored reference codes. If the activation code does correspond to a reference code then the number of increments representing a period of time may be counted and the reference code may be removed from the memory 42.

In example embodiments, the increments may be preset. For example, the increments may be 50 milliseconds. In example embodiments, the increments and may be counted by the base unit 16. When all of the increments have been counted, the base unit 16 may disable the vehicle starter circuit 17. In example embodiments, the vehicle 12 may never be disabled while in operation, but instead the vehicle 12 may only be disabled upon pre-ignition status.

In example embodiments, the base unit 16 may also count a lapsed time beginning when no increments remain to be counted and ending when the handheld unit 14 sends the signal with increments of time to be counted. The lapsed time may then be subtracted from the newly sent increments to be counted. This latter nonlimiting example embodiment is useful for when a dealer has contracted for consecutive periods of vehicle use. The lapsed time deduction may penalize a debtor for non-payment and may prevent use of the vehicle 12 outside of the contracted period.

In example embodiments, the base unit 16 may include a calendar mode to keep track of days and months and adjust increments to be counted consistent with calendar days and months. For instance, most billing periods are monthly but months may have different numbers of days. With the calendar mode, the base unit 16 may adjust the increments by addition or subtraction of a day's worth of increments to fit within the month in which the increments are counted. Using this feature the lender may not need to select activation codes based on a specific number of days or consider events such as leap years.

One of the intended uses of the method of example embodiments is asset protection for lenders. Example embodiments may include the step of sending activation codes to the base unit 16 by a lender via remote server unit 90.

In example embodiments, a method may include a step of providing activation codes to a lender or in an alternative method the lender may be provided reference codes and a means to generate activation codes. The lender may then provide the activation code to a debtor for entry into the keypad 48 or provide activation codes to the handheld unit through another device such as wireless communication device.

In example embodiments, each reference code may represent a number of increments representing a period of time, accordingly, a lender may have the flexibility to provide activation codes corresponding to reference codes that may be substantially similar or identical to loan repayment periods. For example, if payments are due monthly, the lender may select codes that represent one month periods. However, if the lender wishes to provide codes representing different time periods, such as days or weeks, the lender need only select the code representing the desired time period. Codes representing short durations, such as an hour, may be provided by the lender for emergency situations after immobilization or when repossessing an immobilized vehicle. Because the entry of corresponding codes may add increments of time, the lender may also provide multiple activation codes for debtors making multiple payments in advance.

In example embodiments, a method may also include several steps that aid in repayment of debt obligations. For example, when increments of time are counted, a Graphical LCD 50 may provide a visual indication of time remaining. In example embodiments, the piezoelectric buzzer 28 and Graphical LCD 50, may indicate time remaining. In example embodiments, a built in programmable grace period may be included. For monthly time periods, a grace period of several days may be added after the increments of time have been counted. The grace period may give the lender sufficient time to make a payment and receive another activation code before immobilization of the vehicle 12. In example embodiments, the grace period may automatically end when more increments are added to the base unit 16 to be counted.

Thus, example embodiments have been described in an illustrative manner. It is to be understood that the terminology that has been used is intended to be in the nature of words of description rather than of limitation. In example embodiments, many modifications and variations of the present invention are possible in light of the above teachings. For example, the memory 42 may be of any size and may store any number of reference codes. Therefore, within the scope of the appended claims, the present invention may be practiced otherwise than as specifically described.

Example embodiments provide a wide variety of a base units 16 and uses thereof. Below are some specific, nonlimiting examples and uses of the inventions.

1.) Base Unit with attached Touchscreen LCD+GPS+Cellular to Cellular Remote Server

Activation+EMG codes from LCD—Re-enables

Paid up status from Cellular Remote Server—Re-enables

Base Unit Disables Autonomously based on time countdown

### 2.) Base Unit (No Touchscreen LCD)+GPS+Remote KeyFob+Cellular to Cellular Remote Server

Activation+EMG codes from Remote KeyFob—Re-enables

Paid up status from Cellular Remote Server—Re-enables

Base Unit Disables Autonomously based on time countdown

### 3.) Base Unit (No Touchscreen LCD)+GPS+Remote Handset+Cellular to Cellular Remote Server

Activation+EMG codes from Remote Handset—Re-enables

Paid up status from Cellular Remote Server—Re-enables

Base Unit Disables Autonomously based on time countdown

4.) Base Unit with attached Touchscreen LCD+No Cellular+No GPS

Activation+EMG codes from LCD—Re-enables

Base Unit Disables Autonomously based on time countdown

While example embodiments have been particularly shown and described with reference to example embodiments thereof, it will be understood by those of ordinary skill in the art that various changes in form and details may be made therein without departing from the spirit and scope of the invention.

What we claim is:

1. A base unit comprising:
a microprocessor;
a relay connected to the microprocessor; and
at least one transceiver connected to the microprocessor, wherein the microprocessor is configured to receive data related to a number of time increments to count, count a number of time increments, and activate the relay when it determines that no more time is to be counted.

2. The base unit of claim 1, wherein the relay is configured to connect between a starter and an ignition of a vehicle to disable the vehicle when the relay is activated.

3. The base unit of claim 1, wherein the at least one transceiver is configured to receive a signal from a lender to at least one of re-enable the vehicle and keep the vehicle in an enabled condition.

4. The base unit of claim 1, further comprising:
a memory configured to set a check point of time counted.

5. The base unit of claim 1, wherein the base unit is configured to receive a signal from an accessory input sensor.

6. The base unit of claim 5, wherein the processor is configured to determine whether time remains to be counted when the accessory input sensor senses a key in accessory position and, if no time remains to be counted, activates the relay.

7. The base unit of claim 5, wherein if the accessory input sensor senses an accessory off position and if the processor determines there is no more time to count, the relay is not triggered until a preset time period has elapsed.

8. The base unit of claim 5, wherein the microprocessor is configured to activate the relay only before a pre-ignition.

9. The base unit of claim 5, wherein the microprocessor is configured to count lapsed time beginning when no increments remain to be counted and when it receives a signal with new increments of time to be counted.

10. The base unit of claim 9, wherein the microprocessor is further configured to subtract the lapsed time from the new increments of time to be counted.

11. The base unit of claim 1, further comprising:
a signal generator configured to send a signal in the event the microprocessor determines that no more time is to be counted.

12. The base unit of claim 11, wherein the signal generator is a piezoelectric buzzer.

13. The base unit of claim 1, wherein the at least one transceiver is a radio transceiver.

14. The base unit of claim 1, wherein the at least one transceiver is a cellular transceiver.

15. The base of claim 1, further comprising:
a GPS receiver.

16. A system comprised of
an electronic storage device having a memory and a second microprocessor configured to determine whether an activation code correctly corresponds to a reference code stored in the memory, the memory being non-permanent to allow deletion of the reference code determined by said microprocessor to correctly correspond to the activation code; and
the base unit of claim 1, wherein the microprocessor is configured to process a signal from the electronic storage device after the second microprocessor determines the activation code matches the reference code, the signal including the data related to the number of time increments to count.

17. The system of claim 16, wherein the electronic storage device includes a keypad to enter the activation code into the electronic storage device.

18. The system of claim 16, wherein processor is configured to deactivate the relay after receiving the signal from the electronic storage device.

19. The system of claim 16, wherein the relay is configured to deactivate an electrical system of a vehicle.

20. The system of claim 16, wherein the base unit is configured to connect to a vehicle's ignition system.
